(19) United States
(12) Patent Application Publication
(10) Pub. No.: US 2012/0310723 A1
(43) Pub. Date: Dec. 6, 2012

(54) CREDIT AND DEBIT CARD WITH REWARD CHOICE FOR CARD HOLDERS

(76) Inventor: Payam Moradian, Los Angeles, CA (US)

(21) Appl. No.: 13/487,256

(22) Filed: Jun. 4, 2012

Related U.S. Application Data
(60) Provisional application No. 61/492,810, filed on Jun. 3, 2011.

(51) Int. Cl. G06Q 30/02

(52) U.S. Cl. 705/14.27

(57) ABSTRACT

Provided is a method for allowing a debit or credit holder to choose the amount of rewards received depending on a category of purchase.

### CROSS-REFERENCE

The present application claims the benefit of U.S. provisional application No. 61/492,810, filed on Jun. 3, 2011, which is incorporated herein by reference in its entirety.

### BACKGROUND OF THE INVENTION

Almost all credit and debit cards give some sort of rewards to card holders, typically in the form of points based on the amount of money spent by the card holder. These points are then redeemed by the card holder for purchases.

A problem that exists with these reward systems in the lack of choice for card holders since card holders cannot choose the number of points obtained for each purchase. A credit card company often chooses how many points per purchase a card holder obtains, such as one point per dollar spent, with some purchases obtaining two points per dollar spent. This one for all point structure does not reflect the choice and the spending pattern of a card holder, and also fails to give additional reward to the most valuable card holders. There is a need in the art for a credit card reward system that allows card holders to decide the number of points obtained per each dollar (or other currency) spent.

### SUMMARY OF THE INVENTION

Provided is a method for allowing a card holder (or any account holder with or without a card) to choose the amount of rewards received depending on a category of purchase, comprising: a credit or debit card holder; a card network; a card issuer (or any account issuer whether or not providing a card), wherein the card issuer provides the card holder a selection between two or more different categories of purchases and two or more different payout ratios of reward per unit of currency spent, and the card holder selects at least one category of purchase to be at a lower or higher reward pay out ratio relative to other categories of purchases carried out through said card network. The different categories of purchases can be selected from the group consisting of at least one or more of groceries, gasoline, travel, telecommunication (phone bills), restaurants, leisure, air travel, lodging, food, car rental, hotels, automobile, housing, business, rent, drugstore, and combinations thereof. The pay-out ratio can be single, double, triple or quadruple rewards per U.S. dollar spent. The number of selections vary depending on the status of the card holder. The card holder can earn specific or general types of rewards after each purchase. Every or only some category of purchase can earn a reward. The number of categories allowed for a cardholder to choose from is 2 to about 10 choices, or about 4 to about 8 choices.

Provided is a method of maximizing reward for a card holder (or any account holder with or without a card) comprising: a credit or debit card holder, a card network, a card issuer, wherein the card issuer (or any account issuer whether or not providing a card) allows for selection between two or more different categories of purchases and two or more different payout ratios of reward per unit of currency spent, and the card issuer calculates the different combinations of pay-out ratios for each selection a card holder is allowed to make, and the card issuer makes the selection that gives the cardholder the maximum reward for the purchases carried out with the card network for a period of time. The card issuer can make the selection as part of preparing a monthly statement for the card holder. The different categories of purchases can be selected from the group consisting of at least one or more of groceries, gasoline, travel, telecommunication (phone bills), restaurants, leisure, air travel, lodging, food, car rental, hotels, automobile, housing, business, rent, drugstore, and combinations thereof. The pay-out ratio can be single, double, triple or quadruple rewards per U.S. dollar spent. The number of selections vary depending on the status of the card holder. The card holder can earn specific or general types of rewards after each purchase. Every or only some category of purchase can earn a reward. The number of categories allowed for a cardholder to choose from is 2 to about 10 choices, or about 4 to about 8 choices.

The above embodiments are exemplified with a credit or debit card. In one embodiment, the card issuer can be any account issuer that provides rewards, whether or not an actual physical card is issued.

### BRIEF DESCRIPTION OF THE FIGURES

FIG. 1 is a scheme of an embodiment where a card holder is given the choice of selecting different pay-out ratios for at least two or more different categories of purchases, the card hold making such selection, card holder making purchases, and the card issuer awarding points based on the pay-out ratio selected by the holder.

FIG. 2 is a scheme of an embodiment where the card issuer based on the selections available to the card holder makes the determination of what selection obtains the maximum awards at end of a billing cycle (or monthly or quarterly or yearly statement), and awards the maximum points to the card holder.

FIG. 3 is a card holder's computer screen where the card issuer is allowing the card holder to make a selection at to which two out of five categories should obtain double versus single points for each dollar spent.

FIG. 4 is illustrates the interaction between a card a credit or debit card holder, a card network; and a card issuer.

### DETAILED DESCRIPTION OF THE INVENTION

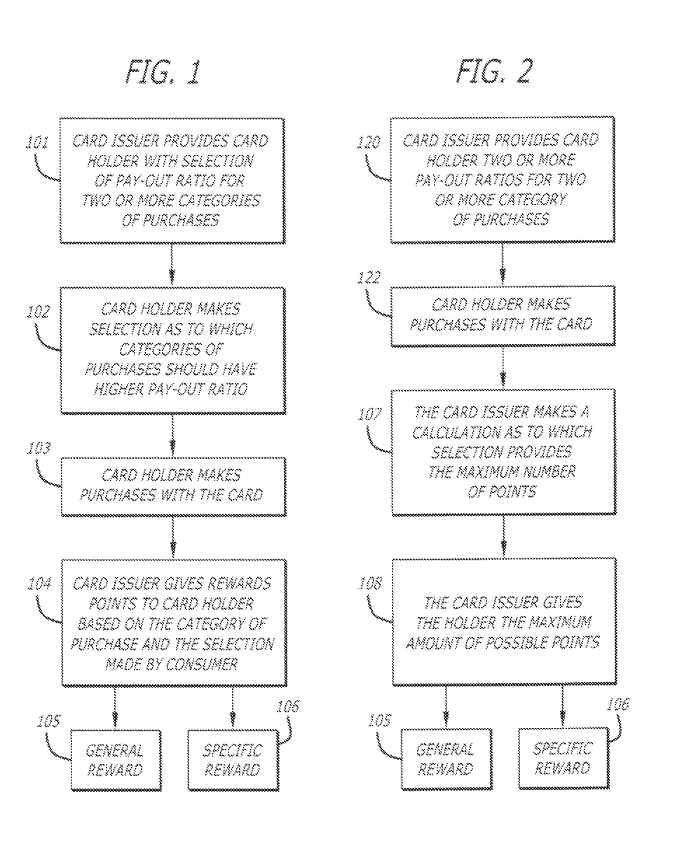

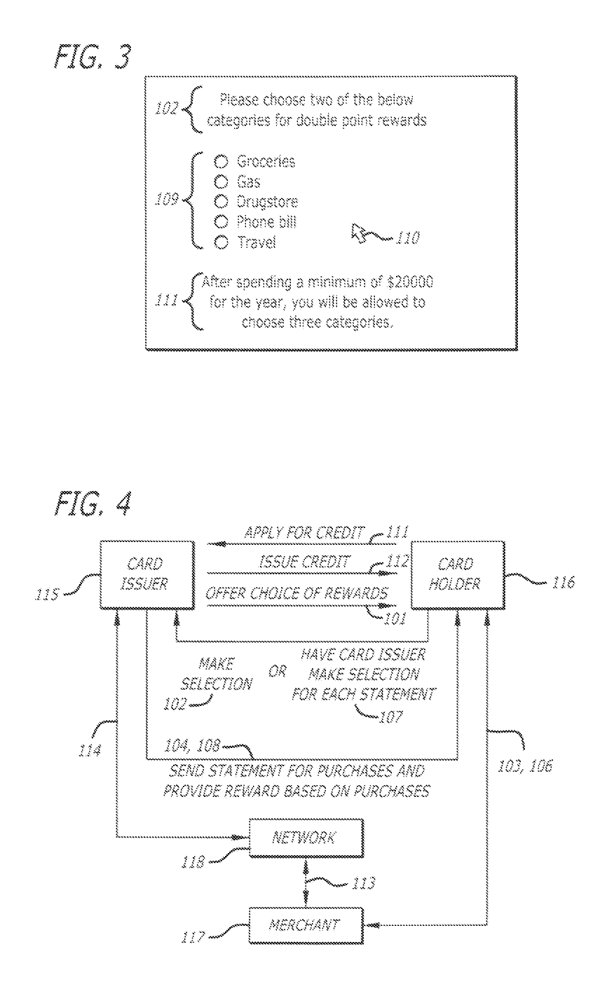

The present invention provides a method (FIG. 1) for allowing a card holder (116) to choose the amount of rewards received depending on the category of purchase. In this method, a card issuer (115) provides a card holder (116) a selection between two or more different categories of purchases (102, 109) and two or more different payout ratios of reward per unit of currency spent (101), and the card holder (116) selects at least one category of purchase to be at a lower or higher reward pay-out ratio relative to other categories (102) of purchases carried out a network (118).

The different categories of purchase (109) can include for example, groceries, gasoline, travel, telecommunication (phone bills), restaurants, leisure, air travel, lodging, food, car rental, hotels, automobile, housing, business, rent, drugstore, and others. The number of categories allowed for a cardholder (116) to choose from can be 2 to about 10 choices, about 4 to about 8 choices, or any other number deemed appropriate by the card issuer (115).

A credit or debit card holder (116) is given a choice as to what purchases should earn single, double, triple or even quadruple points. For example, a simple list of categories can be included such as groceries, gasoline, travel, telecommunication (phone bills), restaurants, and others (109). The card holder (116) is allowed to make in this example one category to obtain double points with the rest single points. A card holder who travels frequently would then choose to receive double points travel, but single points for the rest of the categories.

Some card holders may be more valuable to a credit card company, for example by spending more or having good credit. These card holders can have silver, gold, platinum, titanium, elite or similar status. These card holders can be allowed to pick more categories with double or higher points (111). For example, for the simple list of categories provided above, the card holder is allowed to make in this example two categories to obtain double points with the rest single points. A card holder who travels frequently would then choose to receive double points for travel and restaurants, but single points for the rest of the categories.

In one embodiment, a card holder earns points directly into a specific type of reward (106) without conversion. For example, the credit card holder has an airline card that automatically converts points to airline points.

| Purchases | Conversion rate | Airlines points |
|---|---|---|
| $100 groceries | 1X | 100 |
| $100 phone bill | 1X | 100 |
| $100 travel (hotel) | 2X | 200 |
| $100 restaurant | 1X | 100 |
| | | Total: 500 points |

In another embodiment, the points are put in a general account (105),and then converted to specific points by a card holder. For example, instead of 500 airline points, 500 general points are obtained and are subsequently converted to specific points by the card holder.

In the table provided above, the cardholder earns rewards for every category of purchase. It is possible to also provide a zero conversion rate for some purchases, i.e., some purchases get no rewards.

In another embodiment a determination is made at end of each period:(such as monthly statement) as to what assignment of point system per category would allow for accumulation of the greatest points. For example, the total points in the account if all purchases are at a ratio of 1× is 500. Double points for groceries would allow for a total points of 550 and for travel total points of 630. After doing the calculation of different point assignments, the card holder is awarded double points in this case for travel as this allows the card holder the greatest number of points. This calculation is typically done when a monthly statement is sent out. In the next statement, groceries may provide more points, and the card issuer would select groceries instead of travel to reward the card holder.

This method (FIG. 2) of calculating points afterwards to give a card holder (116) the maximum reward cam comprise the card issuer allowing for selection between two or more different categories of purchases and two or more different payout ratios of reward per unit of currency spent (120), and the card issuer calculates the different combinations of pay-out ratios for each selection a card holder is allowed to make (107), and the card issuer makes the selection that gives the cardholder the maximum reward (108) for the purchases carried out with the card network (118) for a period of time. The period of time is typically that time period where purchases are included in a statement sent to the card holder.

The card holder (116) typically deals with a merchant (117) and the transaction is processed through a network (118). This network (118) receives an account identifier and a purchase identifier from a point-of-sale device. The point-of-sale device can be a credit or debit card reader used by a customer or company employee to swipe a credit or debit card. In a representative embodiment, a credit card includes a magnetic strip which is readable by the card reader. The credit card is read by the reader and account information is communicated along with purchase information to a processing system. In one embodiment, the point of sale is not a physical location but an e-commerce web site accessible over the Internet. In another embodiment, the point-of-sale device is a handheld device such as a PDA, a smart phone, or other such device. The purchase identifier can include information such as the particular product or service being sold and a price for that product or service. The purchase identifier would allow the system to distinguish between different categories of goods and services purchased by the card holder.

A card issuer and a card holder are used to exemplify the invention. As technology advances, an actual physical card may no longer be used. The card issuer may provide an application for a personal computing device rather than a physical card. The invention encompassed any credit or debit account that provides a reward, whether or not an actual card is used.

The card network (118) can be any network that connects the merchant (typically the merchant's bank) (117) to the card issuer (115), and can include Visa®, Discover®, American Express®, and Master Card®.

The card issuer (115) can be any company or institution that issues the card, and typically is a bank (Citibank®, Chase®, Capital One®) that sends the final statement for payment to the card holder.

Also provided is a computerized system for carrying out the method described above.

What is claimed is:

1. A method for allowing a credit or debit account holder to choose amount of rewards received depending on a category of purchase, comprising:
a credit or debit account holder;
a network;
an account issuer;
wherein the account issuer provides the account holder a selection between two or more different categories of purchases and two or more different payout ratios of reward per unit of currency spent, and the account holder selects at least one category of purchase to be at a lower or higher reward pay out ratio relative to other categories of purchases carried out through said network.

2. The method of claim 1, wherein the different categories of purchases are selected from the group consisting of at least one or more of groceries, gasoline, travel, telecommunication (phone bills), restaurants, leisure, air travel, lodging, food, car rental, hotels, automobile, housing, business, rent, drugstore, and combinations thereof.

3. The method of claim 1, wherein the pay-out ratio is single, double, triple or quadruple rewards per U.S. dollar spent.

4. The method of claim 1, wherein the number of selections vary depending on the status of the account holder.

5. The method of claim 1, wherein the account holder earns specific types of rewards after each purchase.

6. The method of claim 1, wherein the account holder earns general types of rewards after each purchase that need to be redeemed.

7. The method of claim 1, wherein every category of purchase of the account holder earns a reward.

8. The method of claim 1, wherein some category of purchases of the account holder earn no reward.

9. The method of claim 1, wherein the number of categories allowed for a accountholder to choose from is 2 to about 10 choices.

10. The method of claim 1, wherein the account issuer provides a credit or debit card.

11. A method of maximizing reward for a debit or credit account holder comprising:
a credit or debit account holder;
a network;
a account issuer;
wherein the account issuer allows for selection between two or more different categories of purchases and two or more different payout ratios of reward per unit of currency spent, and the account issuer calculates the different combinations of pay-out ratios for each selection a account holder is allowed to make, and the account issuer makes the selection that gives the account holder the maximum reward for the purchases carried out with the account network for a period of time.

12. The method of claim 11, wherein the account issuer makes the selection as part of preparing a statement for the account holder.

13. The method of claim 12, wherein the statement is a monthly statement.

14. The method of claim 11, wherein the different categories of purchases are selected from the group consisting of at least one or more of groceries, gasoline, travel, telecommunication (phone bills), restaurants, leisure, air travel, lodging, food, car rental, hotels, automobile, housing, business, rent, drugstore, and combinations thereof.

15. The method of claim 11, wherein the number of selections vary depending on the status of the account holder.

16. The method of claim 11, wherein the account holder earns specific types of rewards after each purchase.

17. The method of claim 11, wherein the account holder earns general types of rewards after each purchase that need to be redeemed.

18. The method of claim 11, wherein every category of purchase of the account holder earns a reward.

19. The method of claim 11, wherein some category of purchases of the account holder earn no reward.

20. The method of claim 11, wherein the number of categories allowed for a accountholder to choose from is 2 to about 10 choices.
